(19) United States
(12) Patent Application Publication
(10) Pub. No.: US 2021/0112907 A1
(43) Pub. Date: Apr. 22, 2021

(54) SMART HELMET, INSPECTION METHOD AND SYSTEM FOR EXPRESS DELIVERY

(71) Applicant: Xiamen University of Technology, Xiamen (CN)

(72) Inventors: Gang WANG, Xiamen (CN); Jian FANG, Xiamen (CN); Gang REN, Xiamen (CN); Guolin ZHANG, Xiamen (CN)

(21) Appl. No.: 17/010,801

(22) Filed: Sep. 2, 2020

(30) Foreign Application Priority Data
Oct. 22, 2019 (CN) 201911005182.0

(51) Int. Cl. A42B 3/30; A42B 3/04; H04L 29/08; H04N 5/76; H04N 7/18

(52) U.S. Cl. CPC A42B 3/30; A42B 3/0433; H04N 7/185; H04N 5/76; H04L 67/10

(57) ABSTRACT

A smart helmet, a method and system for express delivery inspection. The smart helmet includes a helmet body, a controller provided on the helmet body, a wireless communication module and a camera electrically connected to the controller. Wherein the controller includes a memory and a processor. Executable code is stored in the memory, and the executable code can be executed by the processor to implement the following steps: the camera is started to perform video recording after a video recording instruction is received from the cloud server; the video information captured by the camera that the user performs the face-to-face inspection on the express delivery is acquired.

### CROSS-REFERENCE TO RELATED APPLICATIONS

This application claims all benefits accruing under 35 U.S.C. § 119 from China Patent Application No. 201911005182.0, entitled “SMART HELMET, INSPECTION METHOD AND SYSTEM FOR EXPRESS DELIVERY”, filed on Oct. 22, 2019, in the China National Intellectual Property Administration, the content of which is hereby incorporated by reference.

### TECHNICAL FIELD

The present disclosure relates to the field of smart devices, and in particular to a smart helmet, an inspection method and a system for express delivery.

### BACKGROUND

With the popularity of online shopping, the logistics industry has experienced unprecedented development. Online shopping not only greatly facilitates users, but also leads to a series of disputes.

Common disputes can be seen as a responsibility attribution problem when goods are damaged. For example, when a user receives goods and then goes home and unpacks the goods to find problems with the goods, such as the goods does not match the merchant's description or the goods is damaged, it is often difficult to determine the responsibility, which may be caused by the user, or may be caused by the merchant's shipment or the courier company's express delivery process. Although there are requirements for face-to-face inspections, couriers often do not wait for users to inspect for various purposes. In this case, after discovering a problem with the good, the user needs to go through many tedious procedures to return the goods, causing a lot of trouble to the user.

### SUMMARY

The object of the present disclosure is to provide a smart helmet, an inspection method and a system for express delivery to overcome the defect of the prior art, which can realize a quick and reliable face-to-face inspection in the express delivery, so as to determine a relatively clear responsibility attribution.

A smart helmet for express delivery is provided by the embodiment of the present disclosure, including a helmet body, a controller provided on the helmet body and a wireless communication module and a camera electrically connected to the controller; wherein, the controller includes a memory and a processor, executable code is stored in the memory, and the executable code is executable by the processor to perform the following operations:

the camera is started to perform video recording after a video recording instruction is received from the cloud server; wherein, the video recording instruction is generated by the cloud server when the cloud server receives a face-to-face inspection request initiated by the user when receiving an express delivery through a user terminal;

video information captured by the camera from the user performing the face-to-face inspection on the express delivery is acquired; and

the camera is turned off after a stop recording instruction of the cloud server is received, and the acquired video information is sent to the cloud server; wherein, the stop recording instruction is generated by the cloud server when the cloud server receives an inspection completion instruction or a return instruction initiated by the user after receiving the express delivery through the user terminal.

Preferably, the camera is provided at a front end position of the helmet body.

Preferably, a position of the camera on the helmet body is adjustable.

A method for express delivery inspection, includes:

sending a face-to-face inspection request to the cloud server, wherein the face-to-face inspection request includes the express delivery order number of the express delivery to be inspected by the user terminal;

searching, by the cloud server, the corresponding smart helmet of the corresponding courier according to the express delivery order number after receiving the face-to-face inspection request, and sending a video recording instruction to the smart helmet;

starting the camera on the smart helmet to record video after receiving the video recording instruction by the smart helmet, so as to obtain the video information captured by the camera that the user performs the face-to-face inspection on the express delivery.

Preferably, the method further includes:

generating, by the user terminal, the inspection completion instruction according to the operation of the user and sending the inspection completion instruction to the cloud server;

sending, by the cloud server, a stop recording instruction to the smart helmet according to the inspection completion instruction;

turning off, by the smart helmet, the camera according to the stop recording instruction, and sending the video information to the cloud server.

Preferably, the method further includes:

initiating, by the smart terminal bound with the smart helmet, a video information acquisition request to the cloud server, wherein the video information acquisition request includes an express deliver order number;

sending, by the cloud server, the video information corresponding to the express delivery order number to the smart terminal according to the video information acquisition request.

Preferably, the method further includes:

generating, by the user terminal, a return instruction according to the operation of the user, and sending the return instruction to the cloud server;

sending, by the cloud server, a stop recording instruction to the smart helmet;

turning off, by the smart helmet, the camera according to the stop recording instruction, and sending the video information to the cloud server;

sending, by the cloud server, the video information to the merchant terminal corresponding to the express delivery order number.

An express delivery inspection system is further provided by the present embodiment of the present disclosure, including a user terminal, a smart helmet and a cloud server, wherein:

the user terminal is configured to send a face-to-face inspection request to the cloud server, wherein the face-to-face inspection request includes the express delivery order number to be inspected by the user terminal;

the cloud server is configured to find the corresponding smart helmet of the corresponding delivery courier according to the express delivery order number after receiving the face-to-face inspection request, and send a video recording instruction to the smart helmet;

the smart helmet is configured to start the camera on the smart helmet to record after receiving the video recording instruction, so as to obtain the video information captured by the camera that the user performs the face-to-face inspection on the express delivery;

Preferably, the user terminal is configured to generate an inspection completion instruction according to the operation of the user and send the inspection completion instruction to the cloud server;

the cloud server is configured to send a stop recording instruction to the smart helmet according to the inspection completion instruction;

the smart helmet is configured to turn off the camera according to the stop recording instruction and send the video information to the cloud server.

Preferably, the user terminal is further configured to generate a return instruction according to the operation of the user and send the return instruction to the cloud server;

the cloud server is further configured to send a stop recording instruction to the smart helmet;

the smart helmet is further configured to turn off the camera according to a stop recording instruction and send the video information to the cloud server;

the cloud server is further configured to send the video information to the merchant terminal corresponding to the express delivery order number.

In this embodiment, the face-to-face inspection is realized through the cooperation of the user terminal, smart helmet and cloud server, which can ensure that the whole inspection process is realized face-to-face, and the smart helmet of the courier is automatically recorded, so the reliability of the inspection process can be guaranteed, and if there is any problem with the goods in the future, it can be verified again through video information, thereby avoiding the difficulty of where responsibility lies and the unnecessary disputes among merchants, couriers and users.

### BRIEF DESCRIPTION OF THE DRAWINGS

In order to illustrate the technical solution of the present disclosure more clearly, the following will give a brief introduction to the figures needed in the embodiments. Apparently, the figures in the following description are only some embodiments of the present disclosure. For those skilled in the art, other figures can be obtained according to these figures without any creative work.

FIG. 1 is a flow diagram of the method for express delivery inspection provided in the first embodiment of the present disclosure.

FIG. 2 is a structural diagram of the system for express delivery inspection provided by the second embodiment of the present disclosure.

FIG. 3 is a structural diagram of the smart helmet provided by the second embodiment of the present disclosure.

### DETAILED DESCRIPTION OF THE EMBODIMENTS

The technical solution of the present disclosure will be described clearly and completely by the embodiments in combination with the drawings. It is apparent that the described embodiments are only a part of the embodiments of the present disclosure, and not all of the embodiments. Based on the embodiments in the present disclosure, all other embodiments obtained by those skilled in the art without creative labor are within the scope of the present disclosure.

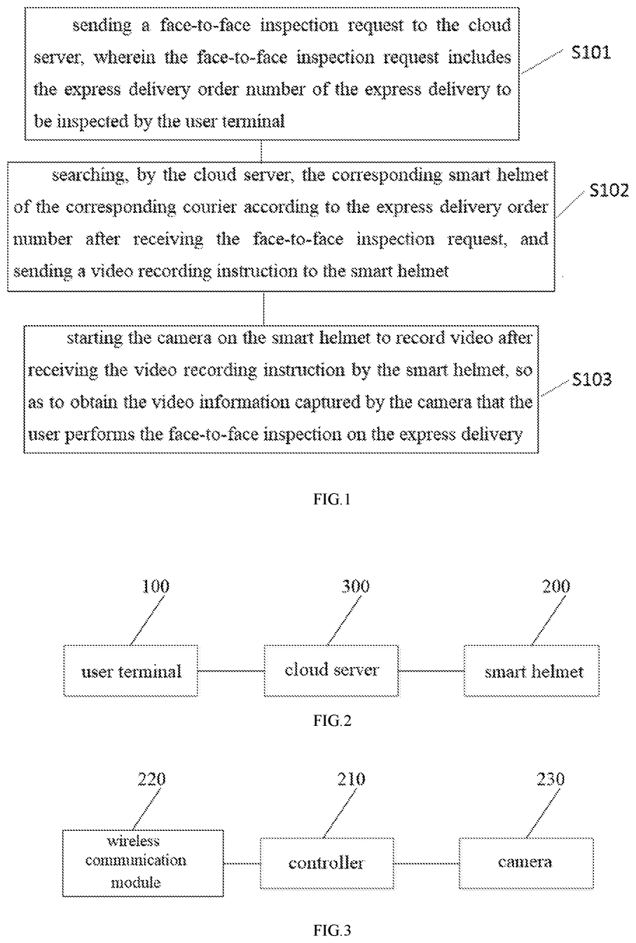

Referring to FIG. 1, a method for express delivery inspection, includes:

S101, sending a face-to-face inspection request to the cloud server, wherein the face-to-face inspection request includes the express delivery order number of the express delivery to be inspected by the user terminal.

In the present embodiment, the user terminal may be a smart phone, and a corresponding e-commerce APP (such as Taobao, JD.com, Tmall, etc.), which may be installed in the smart phone for users to purchase online. After the user completes the online shopping, the e-commerce can assign express information to the goods. After the express information is assigned, the user can obtain the express logistics information of the purchased goods in the e-commerce APP, such as the express delivery order number and the current progress and courier information etc.

In the present embodiment, when the courier is ready to perform express delivery of the goods to the user, the user can initiate a face-to-face inspection request to the cloud server through the e-commerce APP on the user terminal, and the face-to-face inspection request includes the express delivery order number of the goods.

S102, searching, by the cloud server, the corresponding smart helmet of the corresponding courier according to the express delivery order number after receiving the face-to-face inspection request, and sending a video recording instruction to the smart helmet.

In the present embodiment, each courier delivering a goods wears a proprietary smart helmet, and the smart helmet has a unique identifier corresponding to the courier. When the cloud server receives the face-to-face inspection request, it searches for the identifier of the corresponding courier and the corresponding smart helmet through the express delivery order number in the face-to-face inspection request, and sends a recording instruction to the smart helmet through the identifier.

S103, starting the camera on the smart helmet to record video after receiving the video recording instruction by the smart helmet, so as to obtain the video information captured by the camera that the user performs the face-to-face inspection on the express delivery.

In the present embodiment, a camera is installed on the smart helmet, and the smart helmet turns on the camera to record after receiving the recording instruction sent by the cloud server through the wireless communication module. At this time, the user can unpack the express delivery, and the camera can record the video information that the user unpacks the express delivery and verifies the goods. Since the camera is located on the head of the courier, as long as the courier is close to the user and chooses an appropriate angle, the process of unpacking the express delivery can be easily captured without the need for an additional hand-held mobile phone or special recording equipment, which is very easy to operate.

In the present embodiment, after the user unpacks the express delivery and conducts a face-to-face inspection, if he feels that there is no problem with the goods he has purchased, he sends an inspection completion instruction through the e-commerce APP on the user terminal and sends it to the cloud server. The cloud server sends a stop recording instruction to the smart helmet according to the inspection completion instruction. The smart helmet turns off the camera according to the stop recording instruction and sends the video information to the cloud server, thereby completing the entire face-to-face inspection process.

It can be seen that the entire inspection process of the present embodiment is implemented face-to-face, and is automatically recorded by the smart helmet of the courier, so the reliability of the inspection process can be ensured. If there is a problem with the goods in the future, the video information can be used for re-verification to avoid the difficulty of dividing responsibilities and unnecessary disputes between merchants, couriers, and users.

In the present embodiment, after the user unpacked the express delivery and conducts a face-to-face inspection, if he feels that there is a problem with the goods he purchased (such as damage or inconsistency with the merchant's description), the user can issue a return instruction through the user terminal and send the return instruction sent to the cloud server, a stop recording instruction is sent to the smart helmet by the cloud server. The smart helmet turns off the camera according to the stop recording instruction and sends the video information to the cloud server. The video information is sent to the merchant terminal corresponding to the express delivery number by the cloud server.

In this case, the video information is sent to the merchant terminal, so that the merchant can know that the goods in question is the problem with its shipment or the problem in the transportation, so as to determine whether the express delivery company or the merchant should bear the return responsibility. For users, only need to send a return instruction to realize the return, there is no need to upload pictures through the e-commerce APP or contact the merchant to return the goods, and thus the operation is convenient and the user experience is good.

In the present embodiment, the courier may also request the cloud server to obtain video information. Specifically, the courier may initiate a video information acquisition request to the cloud server through a smart terminal bound to the smart helmet. The video information acquisition request includes an express delivery order number. The cloud server sends the video information corresponding to the express delivery order number to the smart terminal according to the video information acquisition request.

Referring to FIG. 2, an express delivery inspection system is provided in the second embodiment of the present disclosure, including a user terminal 100, a smart helmet 200 and a cloud server 300, wherein:

The user terminal 100 is configured to send a face-to-face inspection request to the cloud server 300, wherein the face-to-face inspection request includes the express delivery order number of the express delivery (e.g., goods) to be inspected by the user terminal 100.

The cloud server 300 is configured to find the corresponding smart helmet 200 of the corresponding delivery courier according to the express delivery order number after receiving the face-to-face inspection request, and send a video recording instruction to the smart helmet 200.

The smart helmet 200 is configured to start the camera on the smart helmet 200 to record after receiving the video recording instruction, so as to obtain the video information captured by the camera that the user performs the face-to-face inspection on the express delivery.

Preferably, the user terminal 100 is configured to generate an inspection completion instruction according to the operation of the user and send the inspection completion instruction to the cloud server 300.

The cloud server 300 is configured to send a stop recording instruction to the smart helmet 200 according to the inspection completion instruction.

The smart helmet 200 is configured to turn off the camera according to the stop recording instruction and send the video information to the cloud server 300.

Preferably, the user terminal 100 is further configured to generate a return instruction according to the operation of the user and send the return instruction to the cloud server 300.

The cloud server 300 is further configured to send a stop recording instruction to the smart helmet.

The smart helmet 200 is further configured to turn off the camera according to a stop recording instruction and send the video information to the cloud server 300.

The cloud server 300 is further configured to send the video information to the merchant terminal corresponding to the express delivery order number.

Please refer to FIG. 3, a smart helmet for express delivery is provided in the third embodiment of the present disclosure, including a helmet body, a controller 210 provided on the helmet body and a wireless communication module 220 and a camera 230 electrically connected to the controller210. Wherein, the controller 210 includes a memory and a processor, executable code is stored in the memory, and the executable code is able to executed by the processor to implement following steps:

The camera 230 is started to perform video recording after a video recording instruction is received from the cloud server. Wherein, the video recording instruction is generated by the cloud server when the cloud server receives a face-to-face inspection request initiated by the user received an express delivery through a user terminal.

The video information captured by the camera 230 that the user performs the face-to-face inspection on the express delivery is acquired.

The camera is turned off after a stop recording instruction of the cloud server is received, and the acquired video information is sent to the cloud server. The stop recording instruction is generated by the cloud server when the cloud server receives an inspection completion instruction initiated by the user received the express delivery through the user terminal.

Preferably, the camera 230 is provided at the front end position of the helmet body.

Preferably, the position of the camera on the helmet body is adjustable.

Wherein, the wireless communication module 220 may be a WiFi module or a 4G/5G module, which is not specified limited in the present disclosure.

What is claimed is:

1. A smart helmet for express delivery, comprising a helmet body, a controller provided on the helmet body and a wireless communication module and a camera electrically connected to the controller; wherein, the controller comprises a memory and a processor, executable code is stored in the memory, and the executable code is executable by the processor to implement operations comprising:
the camera is started to perform video recording after a video recording instruction is received from the cloud server; wherein, the video recording instruction is generated by the cloud server when the cloud server receives a face-to-face inspection request initiated by the user received an express delivery through a user terminal;
the video information captured by the camera that the user performs the face-to-face inspection on the express delivery is acquired; and
the camera is turned off after a stop recording instruction of the cloud server is received, and the acquired video information is sent to the cloud server; wherein, the stop recording instruction is generated by the cloud server when the cloud server receives an inspection completion instruction or a return instruction initiated by the user.

2. The smart helmet for express delivery according to claim 1, wherein the camera is provided at a front end position of the helmet body.

3. The smart helmet for express delivery according to claim 1, wherein a position of the camera on the helmet body is adjustable.

4. A method for express delivery inspection, comprising:
sending a face-to-face inspection request to a cloud server, wherein the face-to-face inspection request comprises an express delivery order number of an express delivery to be inspected by the user terminal;
searching, by the cloud server, a corresponding smart helmet of a corresponding courier according to the express delivery order number after receiving the face-to-face inspection request, and sending a video recording instruction to the smart helmet; and
starting a camera on the smart helmet to record video after receiving the video recording instruction by the smart helmet, so as to obtain the video information captured by the camera that a user performs the face-to-face inspection on the express delivery.

5. The method for express delivery inspection according to claim 4, the method further comprises:
generating, by the user terminal, an inspection completion instruction according to an operation of the user and sending the inspection completion instruction to the cloud server;
sending, by the cloud server, a stop recording instruction to the smart helmet according to the inspection completion instruction; and
turning off, by the smart helmet, the camera according to the stop recording instruction, and sending the video information to the cloud server.

6. The method for express delivery inspection according to claim 4, the method further comprises:
initiating, by a smart terminal bound with the smart helmet, a video information acquisition request to the cloud server, wherein the video information acquisition request comprises the express delivery order number;
sending, by the cloud server, the video information corresponding to the express delivery order number to the smart terminal according to the video information acquisition request.

7. The method for express delivery inspection according to claim 4, further comprising:
generating, by the user terminal, a return instruction according to an operation of the user, and sending the return instruction to the cloud server;
sending, by the cloud server, a stop recording instruction to the smart helmet;
turning off, by the smart helmet, the camera according to the stop recording instruction, and sending the video information to the cloud server; and
sending, by the cloud server, the video information to a merchant terminal corresponding to the express delivery order number.

8. A system for express delivery inspection, comprising a user terminal, a smart helmet and a cloud server, wherein:
the user terminal is configured to send a face-to-face inspection request to the cloud server, wherein the face-to-face inspection request comprises an express delivery order number of an express delivery to be inspected by the user terminal;
the cloud server is configured to find the corresponding smart helmet of a corresponding delivery courier according to the express delivery order number after receiving the face-to-face inspection request, and send a video recording instruction to the smart helmet; and
the smart helmet is configured to start a camera on the smart helmet to record after receiving the video recording instruction, so as to obtain a video information captured by the camera that a user performs the face-to-face inspection on the express delivery.

9. The system for express delivery inspection according to claim 8, wherein,
the user terminal is configured to generate an inspection completion instruction according to an operation of the user and send the inspection completion instruction to the cloud server;
the cloud server is configured to send a stop recording instruction to the smart helmet according to the inspection completion instruction; and
the smart helmet is configured to turn off the camera according to the stop recording instruction and send the video information to the cloud server.

10. The system for express delivery inspection according to claim 8, wherein,
the user terminal is further configured to generate a return instruction according to an operation of the user and send the return instruction to the cloud server;
the cloud server is further configured to send a stop recording instruction to the smart helmet;
the smart helmet is further configured to turn off the camera according to the stop recording instruction and send the video information to the cloud server; and
the cloud server is further configured to send the video information to a merchant terminal corresponding to the express delivery order number.
